(19) United States
(12) Patent Application Publication
(10) Pub. No.: US 2011/0161842 A1
(43) Pub. Date: Jun. 30, 2011

(54) SYSTEMS AND METHODS FOR THE RENDERING OF PRINTABLE DATA

(76) Inventor: TIM PREBBLE, Longmont, CO (US)

(21) Appl. No.: 12/651,093

(22) Filed: Dec. 31, 2009

(51) Int. Cl. G06F 3/00

(52) U.S. Cl. 715/760

(57) ABSTRACT

Methods for utilizing existing typesetting applications to render documents specified in a markup language that may include objects not supported by the typesetting application are presented. In some embodiments, the method comprises parsing the document to identify objects not natively supported by the typesetting application and extract information including bounding box information pertaining to the identified objects. The typesetting application may be invoked and provided with bounding box information for the identified objects and with instructions to disregard the identified objects. The output of the typesetting application is parsed to determine layout information that corresponds to the identified objects and the identified objects may be processed using the corresponding layout information. In some embodiments, the methods disclosed may permit the use of the TeX typesetting application with documents specified in OOXML.

### BACKGROUND

1. Technical Field

The present disclosure pertains to the field of printing and in particular, to systems and methods for the rendering of printable data described by markup languages.

2. Description of Related Art

Document processing software allows users to view, edit, process, store, and print documents conveniently. However, before a document can be printed, document content is often described in a markup language. Markup languages permit the textual annotation of a document. Descriptive markup languages can be used to specify structural relationships between parts of the document but typically do not provide any instructions on how the document is to be rendered or presented to end users. On the other hand, procedural and presentational markup languages may include instructions that detail how the document content is to be rendered.

When a document described using a descriptive markup language is rendered, a typesetting program can be used to determine how the document is presented to users. For example, a typesetting system such as TeX may be used to typeset the document prior to final presentation and specify the format and position of printable data on a page. Typesetting systems can take unformatted text and commands as input and produce formatted (laid-out) text as output. However, the use of typesetting systems to render documents can present problems in the modern context because modern markup languages, such as Office Open eXtensible Markup Language (“OOML”), may include descriptions of printable data that the typesetting system may not be able to process. For example, a typesetting system may be incapable of processing vector graphic and image data.

The inability of existing typesetting systems to process the varieties of printable objects that can be described in a markup language such as OOXML may limit the use of existing typesetting systems in practice. In addition, because of the complexity associated with typesetting, it may be expensive and impractical to develop new typesetting software to accommodate new objects in markup languages. Thus, there is a need for systems and methods that permit the use of existing typesetting systems to render non-text and other objects present in markup languages that the typesetting system would not ordinarily process.

### SUMMARY

Consistent with disclosed embodiments, systems and methods for rendering printable data specified in a markup language using existing typesetting systems are presented. In some embodiments, a method for rendering at least one page in a document using a typesetting application, wherein the document is described using a markup language, which includes objects not natively supported by the typesetting application, may comprise: parsing the document to identify at least one object not natively supported by the typesetting application and extract information including bounding box information pertaining to the identified object; invoking the typesetting application, wherein the typesetting application is provided with bounding box information for the identified object and instructions to disregard the identified object; parsing the output of the typesetting application to correlate layout information pertaining to the identified object with the identified object; and processing the identified object using layout information corresponding to the identified object.

Embodiments disclosed also relate to methods created, stored, accessed, or modified by processors using computer-readable media or computer-readable memory.

These and other embodiments are further explained below with respect to the following figures.

### BRIEF DESCRIPTION OF THE DRAWINGS

FIG. 1 shows a block diagram illustrating exemplary components in a system for rendering printable data specified in a markup language using existing typesetting systems.

FIG. 2 shows a high-level block diagram of an exemplary printer capable of executing an application for rendering printable data specified in a markup language using existing typesetting systems.

FIG. 3 shows exemplary process flow illustrating steps in a method for executing portions of an application to render printable data specified in a markup language using existing typesetting systems.

FIG. 4 shows a flowchart illustrating an exemplary method for processing OOXML documents using the TeX typesetting application.

FIG. 5 shows a flowchart illustrating details of step 450 for processing non-TeX objects used in exemplary method 400.

### DETAILED DESCRIPTION

In accordance with embodiments reflecting various features of disclosed embodiments, systems and methods for rendering printable data specified in a markup language using existing typesetting systems are presented. In some embodiments, the printable data may take the form of a markup language description of a document. For example, a document may be described using OOXML and typesetting software such as TeX may be used to render the document using described techniques. These techniques may be extended in various ways as would be apparent to one of ordinary skill in the art. Note that in traditional systems, the typesetting software may not support one or more objects supported by the markup language. For example, TeX does not independently support the typesetting of vector graphics and image objects that may be described using OOXML.

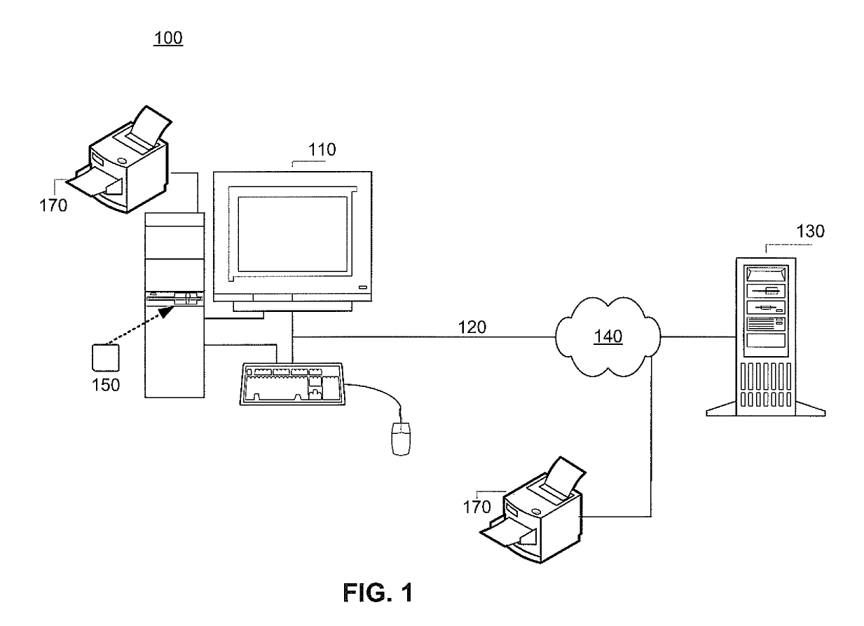

FIG. 1 shows a block diagram illustrating components in a system for rendering printable data specified in a markup language using existing typesetting systems. A computer software application consistent with disclosed embodiments may be deployed on a network of computers, as shown in FIG. 1, that are connected through communication links that allow information to be exchanged using conventional communication protocols and/or data port interfaces.

As shown in FIG. 1, exemplary system 100 includes computers including a computing device 110 and a server 130. Further, computing device 110 and server 130 may communicate over a connection 120, which may pass through network 140, which in one case could be the Internet. Computing device 110 may be a computer workstation, desktop computer, laptop computer, or any other computing device capable of being used in a networked environment. Server 130 may be a platform capable of connecting to computing device 110 and other devices (not shown). Computing device 110 and server 130 may be capable of executing software (not shown) that allows the printing of documents using printers 170.

Exemplary printer 170 includes devices that produce physical documents from electronic data including, but not limited to, laser printers, ink-jet printers, LED printers. Exemplary printer 170 may take the form of a plotter, facsimile machine, multi-function device, digital copier, etc. In some embodiments, printer 170 may also be capable of directly printing documents received from computing device 110 or server 130 over connection 120. In some embodiments, such an arrangement may allow for the direct printing of documents, with (or without) additional processing by computing device 110 or server 130. In some embodiments, documents may be described using a markup language such as OOXML and may contain one or more of text, graphics, and images. In some embodiments, printer 170 may receive the OOXML descriptions of documents for printing. Note, too, that document print processing can be distributed. Thus, computing device 110, server 130, and/or the printer may perform portions of document print processing such as markup language parsing, pre-processing, typesetting, rasterization, half-toning, color matching, and/or other manipulation processes before a document is physically printed by printer 170.

Computing device 110 also contains removable media drive 150. Removable media drive 150 may include, for example, 3.5 inch floppy drives, CD-ROM drives, DVD ROM drives, CD±RW or DVD±RW drives, USB flash drives, and/or any other removable media drives consistent with disclosed embodiments. In some embodiments, portions of the software application may reside on removable media and be read and executed by computing device 110 using removable media drive 150.

Connection 120 couples computing device 110, server 130, and printer 170 and may be implemented as a wired or wireless connection using conventional communication protocols and/or data port interfaces. In general, connections 120 can be any communication channel that allows transmission of data between the devices. In one embodiment, for example, the devices may be provided with conventional data ports, such as parallel ports, serial ports, Ethernet, USB, SCSI, FIREWIRE, and/or coaxial cable ports for transmission of data through the appropriate connection. The communication links could be wireless links or wired links or any combination consistent with disclosed embodiments that allows communication between the various devices.

Network 140 could include a Local Area Network (LAN), a Wide Area Network (WAN), or the Internet. Printer 170 may be connected to network 140 through connection 120. In some embodiments, printer 170 may also be connected directly to computing device 110 and/or server 130. System 100 may also include other peripheral devices (not shown), according to some embodiments. A computer software application consistent with the disclosed embodiments may be deployed on any of the exemplary computers, as shown in FIG. 1. For example, computing device 110 could execute software that may be downloaded directly from server 130. Portions of the application may also be executed by printer 170 in accordance with disclosed embodiments.

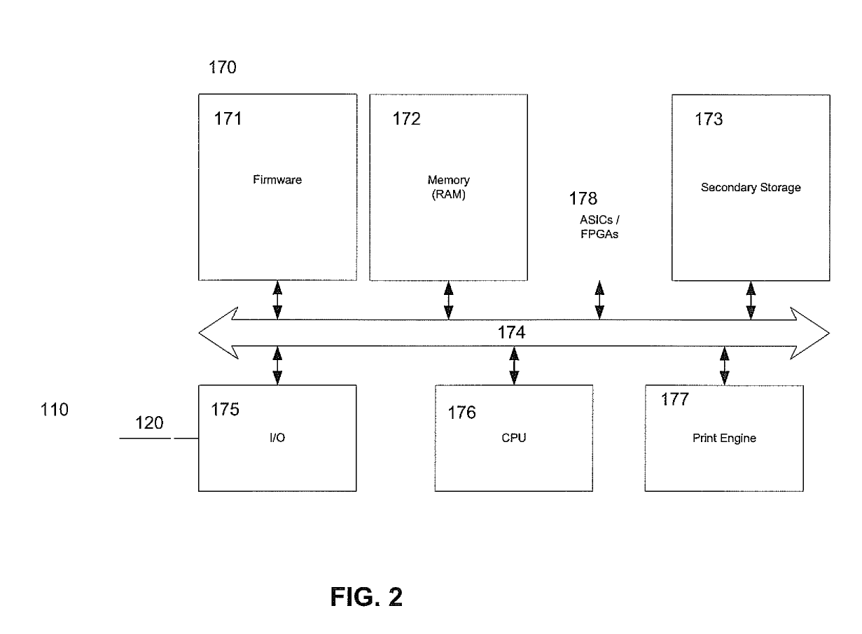

FIG. 2 shows a high-level block diagram of exemplary printer 170 capable of executing an application for rendering printable data specified in a markup language using existing typesetting systems. In some embodiments, printer 170 may contain bus 174 that couples CPU 176, firmware 171, memory 172, input-output ports 175, print engine 177, and secondary storage device 173. Printer 170 may also contain other Application Specific Integrated Circuits (ASICs), and/or Field Programmable Gate Arrays (FPGAs) 178 that are capable of executing portions of an application to render printable data specified in a markup language using existing typesetting systems in a manner consistent with disclosed embodiments. In some embodiments, printer 170 may also be able to access secondary storage or other memory in computing device 110 using I/O ports 175 and connection 120. In some embodiments, printer 170 may also be capable of executing software including a printer operating system, document parsing software, rasterization and typesetting software, and other appropriate application software. In some embodiments, printer 170 may allow paper sizes, output trays, color selections, and print resolution, among other options, to be user-configurable.

In some embodiments, CPU 176 may be a general-purpose processor, a special purpose processor, or an embedded processor. CPU 176 can exchange data including control information and instructions with memory 172 and/or firmware 171. Memory 172 may be any type of Dynamic Random Access Memory (“DRAM”) such as, but not limited to, SDRAM, or RDRAM. Firmware 171 may hold instructions and data including but not limited to a boot-up sequence and pre-defined routines for document parsing, language processing, rasterization, typesetting, and half-toning, routines, as well as other code. In some embodiments, code and data in firmware 171 may be copied to memory 172 prior to being acted upon by CPU 176. Routines in firmware 171 may include code to process and print documents described using markup languages such as OOXML, which may be received from computing device 110. In some embodiments, firmware 171 may include routines to invoke existing typesetting programs such as TeX, routines to create and rasterize display lists to an appropriate pixmap and store the pixmap in memory 172. Firmware 171 may also include compression routines and memory management routines. In some embodiments, data and instructions in firmware 171 may be upgradeable.

In some embodiments, CPU 176 may act upon instructions and data and provide control and data to ASICs/FPGAs 178 and print engine 177 to generate printed documents. In some embodiments, ASICs/FPGAs 178 may also provide control and data to print engine 177. FPGAs/ASICs 178 may also implement one or more of translation, compression, and rasterization algorithms.

In some embodiments, computing device 110 may send printable data in a document specified using a markup language to printer 170. Then, printer 170 may invoke routines to parse the marked-up document to extract text and other non-text objects. Non-text objects may include vector graphics and image objects. Printer may 170 may then process the text and non-text objects by invoking typesetting and other graphics library routines to render the printable data into a final form of printable data and print according to this final form, which may take the form of a pixmap. In some embodiments, the translation process from a markup language description of a document to the final printable data may include the generation of intermediate printable data comprising of display lists of objects.

In some embodiments, display lists may hold one or more of graphics and image data objects. In some embodiments, objects in display lists may correspond to similar objects in a user document. In some embodiments, display lists may aid in the generation of intermediate or final printable data. In some embodiments, display lists and/or pixmaps may be stored in memory 172 or secondary storage 173. Exemplary secondary storage 173 may be an internal or external hard disk, memory stick, or any other memory storage device capable of being used in printer 170. In some embodiments, the display list may reside on one or more of printer 170, computing device 110, and server 130. Memory to store display lists and/or pixmaps may include dedicated memory or may form part of general purpose memory, or some combination thereof according to some embodiments. In some embodiments, memory may be dynamically allocated to hold display lists and/or pixmaps as needed. In some embodiments, memory allocated to store display lists and/or pixmaps may be dynamically released after processing.

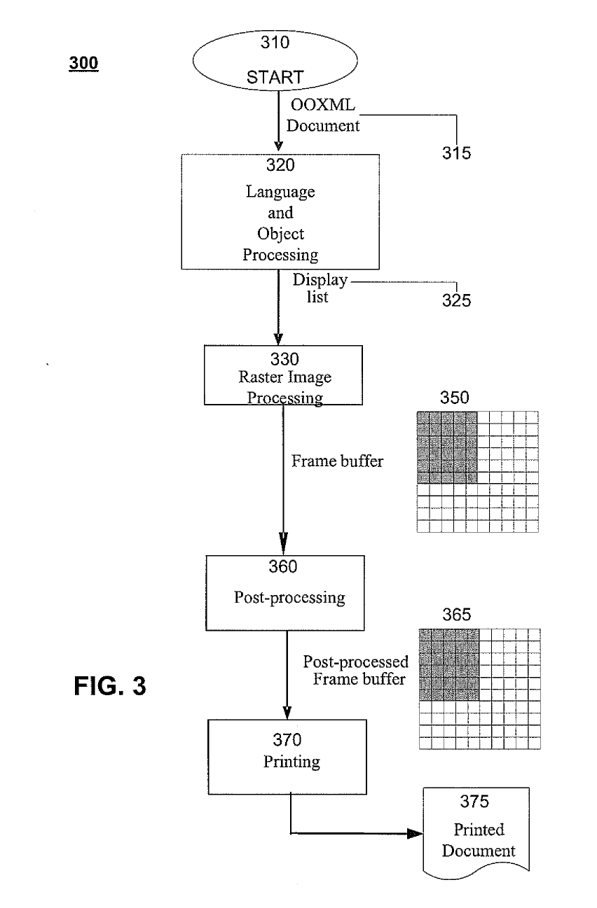

FIG. 3 shows exemplary process flow 300 illustrating steps in a method for executing portions of an application to render printable data specified in a markup language using existing typesetting systems. The process may start in step 310 with the initiation of a print job, which, in some instances, may be a document specified in a markup language such as OOXML.

In step 320, the document 315 can also be subjected to language and object processing. For example, data in the document may be parsed by an OOXML parser to identify individual objects (such as text, images, and graphics). OOXML parsing may also be used provide some preliminary information about object positioning and extent. For example, printable data in the document may be categorized as text, image, and graphics data.

In one embodiment, an internal object may be created to represent the graphic or image data. The object may include information about the graphic or image that is provided by OOXML and extracted by the parser. For example, OOXML may provide geometrical transformation, fill, and stroke color information for graphic objects, and provide filenames identifying the file holding the native image data. In situations where the existing typesetting application cannot independently process or does not natively support one or more objects identified by the parser, information pertaining to these objects may be hidden from the typesetting application, or the typesetting application may be instructed to disregard the objects. Instead, the typesetting application may be given the bounding box of the object for use in layout calculations. In some embodiments, the typesetting application may simply copy information related to the hidden objects from the input document and replicate the information in its output.

For example, in situations where the document is described in OOXML and TeX is used as the typesetting application, OOXML objects that TeX cannot independently process are identified and may be encapsulated within “\special” commands. The term “non-TeX” objects is used to refer to objects that TeX cannot independently process or objects that TeX does not natively support. TeX may also be provided with bounding box information for the encapsulated non-TeX objects when invoked. The bounding box information may be used in layout computations performed by TeX. As a consequence, TeX may determine the positions of the various non-TeX objects, but without directly processing the objects themselves. The method described above may be easily extended to other typesetting languages by one of ordinary skill in the art using available features and language constructs. When TeX encounters the “\special” command, TeX may simply transfer the encapsulated portion to the output it produces without further processing.

The output produced by the typesetting application can be further parsed to correlate layout information for objects not processed by the typesetting application with the objects themselves. The “\special” command instructs TeX to ignore or disregard information within its encapsulated portion. The encapsulated portion of the “\special” command may include a reference such as a pointer to the object. The pointer may be used to correlate the layout information provided by TeX with the object itself.

These operations may result in the placement of graphic primitives that describe the graphics object in display list 325. In some embodiments, language processing and object pre-processing may be performed by a markup language parser such as an OOXML parser and other associated routines. Exemplary display list 325 may be an intermediate step in the processing of data prior to actual printing and may be parsed further before conversion into a subsequent form. Display list 325 may include such information as color, opacity, boundary information, and depth for display list objects.

The conversion process from a display list representation to a form suitable for printing on physical media may be referred to as rasterizing the data or rasterization. In some embodiments, rasterization may be performed by a Raster Image Processor in step 330. For example, basic rasterization may be accomplished by taking a three dimensional scene, typically described using polygons, and rendering the three dimensional scene onto a two dimensional surface. Polygons can be represented as collections of triangles. A triangle may be represented by three vertices in the three dimensional space. A vertex defines a point, an endpoint of an edge, or a corner of a polygon where two edges meet. Thus, basic rasterization may transform a stream of vertices into corresponding two dimensional points and fill in the transformed two dimensional triangles. Upon rasterization, the rasterized data may be stored in a frame buffer, such as exemplary frame buffer 350, which may be physically located in memory 172.

In step 330, Raster Image Processing (RIP) module may process objects in display list 325 and generate a rasterized equivalent in frame buffer 350. In some embodiments, raster image processing may be performed by printer 170. For example, raster image processing may be performed by printer 170 using one or more of CPU 176, ASICs/FPGAs 178, memory 172, and/or secondary storage 173. Raster image processing may be performed by printer 170 using some combination of software, firmware, and/or specialized hardware such as ASICs/FPGAs 178. Frame buffer 350 may hold a representation of print objects in a form suitable for printing on a print medium by print engine 177.

In some embodiments, data in frame buffer 350 may be subjected to post-processing in step 360. For example, various operations such as half-toning, trapping, etc may be carried out on the data in frame buffer 350. As a consequence of these operations, the data in frame buffer is altered resulting in post-processed frame buffer 365. Post-processed frame buffer 365 may then be subjected to any additional processing in step 370. For example, print engine 177, may process the rasterized post-processed data in frame buffer 365, and form a printable image of the page on a print medium, such as paper.

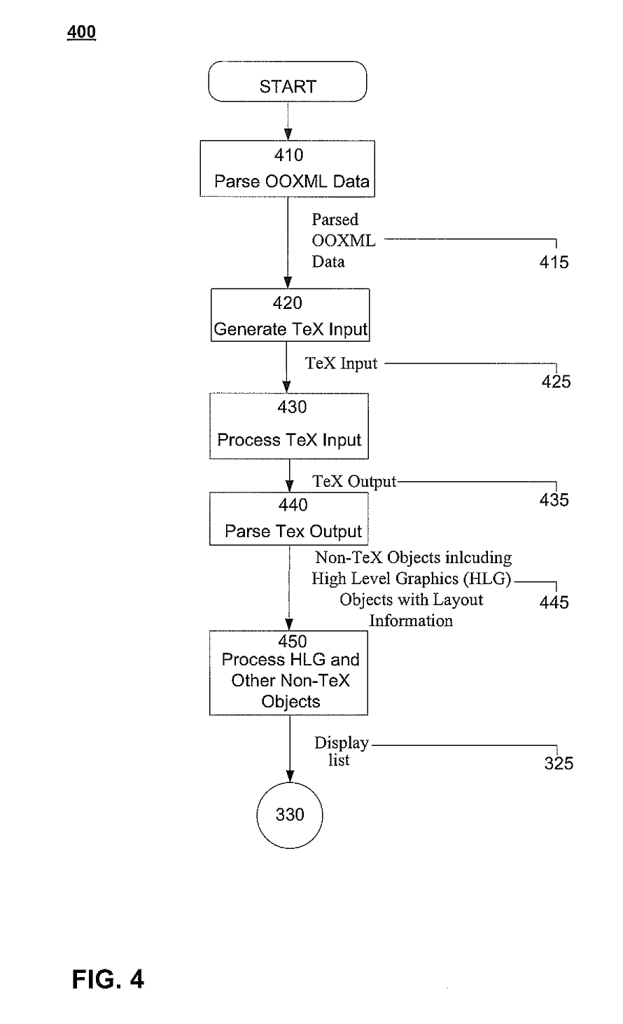

FIG. 4 shows a flowchart illustrating an exemplary method 400 for processing OOXML documents using the TeX typesetting application. Note that method 400 is shown for descriptive purposes only and that the method may be extended to documents described using other markup languages and/or other typesetting applications as would be apparent to one of ordinary skill in the art. In one embodiment, exemplary method 400 may be performed as part of language and object processing step 320. In some embodiments, portions of exemplary method 400 may be performed during Raster Image Processing step 330. In general, method 400 may be implemented in a variety of ways depending on printing system parameters and implementation details, as well as on markup language and typesetting application used.

Exemplary method 400 may be invoked when a document, which may be may be described using OOXML, is sent to printer 170. In some embodiments, OOXML data in the document may be parsed in step 410. For example, the parsing routine may identify data that TeX is capable of processing and also identify other non-TeX data when generating parsed OOXML data 415. For example, printable data in the document can be categorized as text, image, and graphics data. TeX data may include data such as text, which TeX can process. On the other hand, non-TeX data refers to data such as graphics and image objects that TeX may be incapable of processing independently. Graphics data may include High Level Graphics (“HLG”) data, which may be constructed from underlying graphics primitives.

The OOXML description may also provide geometrical transformation, fill, and stroke color information for graphic objects, and provide filenames identifying the files holding the native image data. The parsing routine may extract this information from the OOXML description and provide some preliminary information about object positioning and extent for the non-TeX objects.

Parsed OOXML data 415 may be processed in step 420 to generate TeX input 425 for the TeX typesetting application. In one embodiment, TeX input 425 may include an internal object created to represent the graphic or image data. The object may include information about the graphics or image data that has been extracted by the parser in step 410. For example, pointers to graphics, image and other non-TeX objects may be encapsulated using “\special” commands in TeX input 425, which instruct TeX to ignore information within the encapsulated section. Specifically, pointers to objects may be encapsulated using TeX commands such as “\special {text}”, where “{text}” can be any character string (i.e. in plain text). Thus, “{text}” may be used to refer to pointers written as character strings. In addition, information pertaining to the bounding box for each of the encapsulated objects may be generated in TeX input 425 outside the encapsulated section for passing to TeX.

In step 430, the TeX input may be processed. For example, the TeX typesetting application may be invoked and instructed to operate on TeX input 425 to produce TeX output 435. Tex may process and typeset the text objects in TeX input 425. In addition, TeX may use information pertaining to the bounding boxes of each of the encapsulated objects in layout computations. As a consequence, TeX may determine the positions of the various non-TeX objects, but without directly processing the objects themselves. TeX may generate TeX output 435 after processing TeX and non-Tex objects as described above.

In step 440, TeX output 435 may be parsed. The TeX output parser may associate the layout information produced by TeX with the corresponding non-TeX object using the pointer or other object reference information embedded in the “/special” commands. In step 450, Non-TeX objects including any HLG objects with associated layout information 445 may be processed individually. For example, for an image object, the native image data may be read using the filename embedded in the image object. Graphics and HLG objects may also be processed by invoking graphics libraries. For example, graphics objects may be processed by performing “fill” and “stroke” operations on the objects. These operations may result in graphic primitives that describe the graphics object being placed in display list 325.

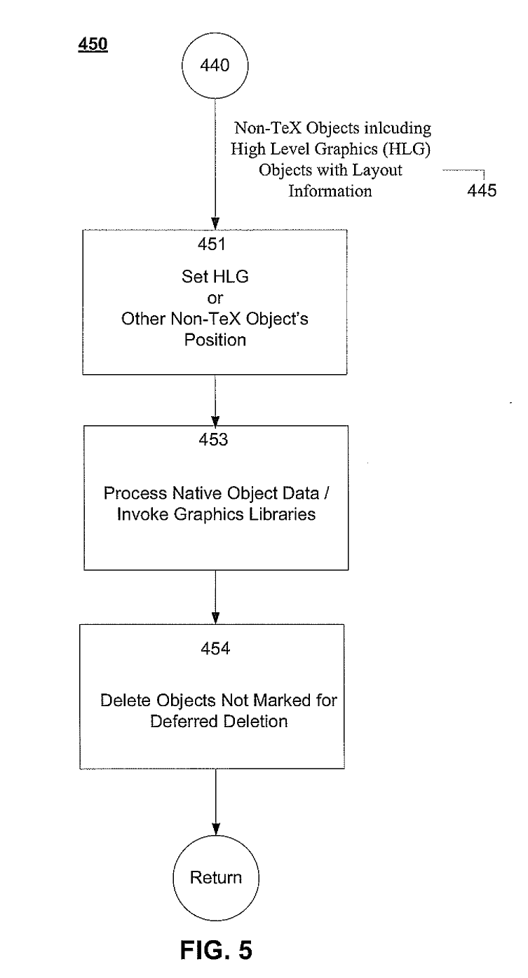

FIG. 5 shows a flowchart illustrating details of step 450 for processing non-TeX objects used in exemplary method 400. In some embodiments, layout information associated with non-TeX objects including HLG objects 445 may be used to set the position of non-Tex objects including any HLG objects, in step 451. In step 453, image, graphics and HLG objects may be processed. For example, for an image object, the native image data may be read using the filename embedded in the image object. Graphics and HLG objects may also be processed by invoking appropriate graphics libraries, which may result in graphic primitives that describe the objects being placed in display list 325. Next, in step 454, objects not marked for deferred deletion may be deleted. For example, certain attributes such as color objects, fill patterns, etc. may be re-used during processing and may be marked for deferred deletion thereby speeding up the rendering process. Other objects may be deleted immediately thereby freeing up memory.

Other implementations will be apparent to those skilled in the art from consideration of the specification and practice of disclosed embodiments. It is intended that the specification and examples be considered as exemplary only, with its true scope and spirit being indicated by the following claims.

What is claimed is:

1. A processor implemented method for rendering at least one page in a document using a typesetting application, wherein the document is described using a markup language, which includes objects not natively supported by the typesetting application, the method comprising:
parsing the document to identify at least one object not natively supported by the typesetting application and extract information including bounding box information pertaining to the identified object;
invoking the typesetting application, wherein the typesetting application is provided with bounding box information for the identified object and instructions to disregard the identified object;
parsing the output of the typesetting application to determine layout information that corresponds to the identified object; and
processing the identified object using the layout information corresponding to the identified object.

2. The processor implemented method of claim 1, wherein the document is described in OOXML.

3. The processor implemented method of claim 1, wherein the typesetting application is TeX.

4. The processor-implemented method of claim 1, wherein the typesetting application responds to the instructions to disregard the identified object by replicating text, which is associated with the input identified object, in the output produced by the typesetting application.

5. The processor-implemented method of claim 1, wherein the typesetting application computes layout information for the identified object based on the bounding box information for the identified object.

6. The processor implemented method of claim 1, wherein the at least one identified object may be a graphics or image object.

7. The processor implemented method of claim 1, wherein the method is performed on:
a computer;
a printer; or
a printer coupled to a computer.

8. The processor implemented method of claim 1, wherein processing the at least one identified object using layout information corresponding to the identified object further comprises:
setting the position of the at least one identified object on the page;
reading native image data from a file associated with the at least one identified object, if the identified object is an image object;
invoking appropriate graphics library routines to process the at least one identified object, if the identified object is a graphic object;
marking the at least one identified object, if the object will be reused; and
deleting the at least one identified object, if the object is unmarked.

9. The processor implemented method of claim 1, further comprising rendering the at least one page with the at least one identified object in accordance with layout information provided by the typesetting application.

10. A computer-readable medium that stores instructions, which when executed by a processor perform a method for rendering at least one page in a document using a typesetting application, wherein the document is described using a markup language, which includes objects not natively supported by the typesetting application, the method comprising:
parsing the document to identify at least one object not natively supported by the typesetting application and extract information including bounding box information pertaining to the identified object;
invoking the typesetting application, wherein the typesetting application is provided with bounding box information for the identified object and instructions to disregard the identified object;
parsing the output of the typesetting application to determine layout information that corresponds to the identified object; and
processing the identified object using the layout information corresponding to the identified object.

11. The computer-readable medium of claim 10, wherein the document is described in OOXML.

12. The computer-readable medium of claim 10, wherein the typesetting application is TeX.

13. The computer-readable medium of claim 10, wherein the typesetting application responds to the instructions to disregard the identified object by replicating text, which is associated with the input identified object, in the output produced by the typesetting application.

14. The computer-readable medium of claim 10, wherein the typesetting application computes layout information for the identified object based on the bounding box information for the identified object.

15. The computer-readable medium of claim 10, wherein the at least one identified object may be a graphics or image object.

16. The computer-readable medium of claim 10, wherein the method is performed on:
a computer;
a printer; or
a printer coupled to a computer.

17. The computer-readable medium of claim 10, wherein processing the at least one identified object using layout information corresponding to the identified object further comprises:
setting the position of the at least one identified object on the page;
reading native image data from a file associated with the at least one identified object, if the identified object is an image object;
invoking appropriate graphics library routines to process the at least one identified object, if the identified object is a graphic object;
marking the at least one identified object, if the object will be reused; and
deleting the at least one identified object, if the object is unmarked.

18. A computer-readable memory that stores instructions, which when executed by a processor perform a method for rendering at least one page in a document using a typesetting application, wherein the document is described using a markup language, which includes objects not natively supported by the typesetting application, the method comprising:
parsing the document to identify at least one object not natively supported by the typesetting application and extract information including bounding box information pertaining to the identified object;
invoking the typesetting application, wherein the typesetting application is provided with bounding box information for the identified object and instructions to disregard the identified object;
parsing the output of the typesetting application to determine layout information that corresponds to the identified object; and
processing the identified object using the layout information corresponding to the identified object.

19. The computer-readable memory of claim 18, wherein the document is described in OOXML.

20. The computer-readable memory of claim 18, wherein the typesetting application is TeX.
